(19) United States
(12) Patent Application Publication
(10) Pub. No.: US 2024/0256148 A1
(43) Pub. Date: Aug. 1, 2024

(54) DOUBLE PARITY RAID TO IMPROVE DISK UTILIZATION

(71) Applicant: Dell Products L.P., Round Rock, TX (US)

(72) Inventors: Jamin Jianbin Kang, Beijing (CN); Jian Gao, Beijing (CN); Vamsi K Vankamamidi, Hopkinton, MA (US)

(73) Assignee: Dell Products L.P., Round Rock, TX (US)

(21) Appl. No.: 18/163,095

(22) Filed: Feb. 1, 2023

(51) Int. Cl. G06F 3/06

(52) U.S. Cl. CPC G06F 3/0619; G06F 3/064; G06F 3/0659; G06F 3/0689

(57) ABSTRACT

Techniques for double parity RAID are disclosed. For example, a system includes a processor coupled to a memory. The processor is configured to: receive a request to store data in data storage disks, wherein the received data is segmented into data blocks; create a distributed parity block P, wherein the distributed parity block is calculated based on the data; select a given data storage disk among the data storage disks to store the distributed plurality block, wherein the given data storage disk is rotated among the data storage disks; write the data blocks to each data storage disk among the data storage disks except the selected data storage disk; write the distributed parity block to the selected data storage disk; create a dedicated parity block Q, wherein the dedicated parity block is calculated based on the data; and write the dedicated parity block to a parity disk.

### FIELD

Example embodiments generally relate to data storage, e.g., providing data redundancy and error correction for disk utilization. More specifically, at least some embodiments relate to systems, hardware, software, computer-readable media, and methods for providing double parity RAID (Redundant Array of Inexpensive Disks) storage in computer systems.

### BACKGROUND

Computer systems are constantly improving in terms of speed, reliability, and processing capability. Computer systems that process and store large amounts of data typically include one or more processors in communication with a shared data storage system in which the data is stored. The data storage system may include one or more storage devices, usually of a fairly robust nature and useful for storage spanning various temporal requirements, e.g., disk drives. The one or more processors perform their respective operations using the storage system. Mass storage systems typically include an array of a plurality of disks with on-board intelligent and communications electronics and software for making the data on the disks available.

Companies that sell data storage systems and the like are concerned with providing customers with an efficient data storage solution that minimizes cost while meeting customer data storage needs. It would be beneficial for such companies to have a way for reducing the complexity of implementing data storage.

### SUMMARY

In one embodiment, a system comprises at least one processing device including a processor coupled to a memory, the at least one processing device being configured to implement the following steps: receiving a request to store data in a plurality of data storage disks, wherein the received data is segmented into a plurality of data blocks; creating a distributed parity block P, wherein the distributed parity block is calculated based on the received data; selecting a given data storage disk among the plurality of data storage disks to store the distributed plurality block, wherein the given data storage disk is rotated among the plurality of data storage disks; writing the data blocks to each data storage disk among the plurality of data storage disks except the selected data storage disk; writing the distributed parity block to the selected data storage disk; creating a dedicated parity block Q, wherein the dedicated parity block is calculated based on the received data; and writing the dedicated parity block to a parity disk.

In some embodiments, the distributed parity block P comprises a horizontal parity calculated based on the data blocks. The horizontal parity can be calculated using bitwise exclusive or (XOR) operations based on the data blocks. The dedicated parity block Q can include a horizontal parity calculated based on the data blocks. The horizontal parity can be calculated using Reed-Solomon coding, Galois field arithmetic, or matrix operations based on the data blocks. The parity disk can include a standalone dedicated disk. The data blocks can be written according to one of a left asymmetric layout, a left symmetric layout, a right asymmetric layout, and a right symmetric layout. The distributed parity block can be written according to one of a left asymmetric layout, a left symmetric layout, a right asymmetric layout, and a right symmetric layout. A capacity of the parity disk can be included in a reserved capacity of a redundancy engine. The reserved capacity can include a spare capacity or a parity capacity of the redundancy engine.

In another embodiment, a method comprises: receiving a request to convert a double parity RAID array into a single parity RAID array, the double parity RAID array including a plurality of data storage disks and a parity disk, wherein the data storage disks are configured to store a plurality of data blocks and a plurality of distributed parity blocks, and the parity disk is configured to store a plurality of dedicated plurality blocks; and reclaiming the parity disk in a redundancy engine by removing the parity disk as parity capacity in the redundancy engine, without a need to perform transfer operations on the data blocks or the distributed parity blocks stored on the data storage disks.

In some embodiments, the parity disk is reclaimed as spare capacity in the redundancy engine. The parity disk can be reclaimed as usable capacity in the redundancy engine. The parity disk can be a standalone dedicated disk. A capacity of the parity disk can be included in a spare capacity of a redundancy engine. The single parity RAID array can be a RAID 5 array.

Other example embodiments include, without limitation, apparatus, systems, methods, and computer program products comprising processor-readable storage media.

Other aspects of the invention will be apparent from the following description and the amended claims.

### BRIEF DESCRIPTION OF THE DRAWINGS

The foregoing summary, as well as the following detailed description of exemplary embodiments, will be better understood when read in conjunction with the appended drawings. For purposes of illustrating the invention, the drawings illustrate embodiments that are presently preferred. It will be appreciated, however, that the invention is not limited to the precise arrangements and instrumentalities shown.

To easily identify the discussion of any particular element or act, the most significant digit or digits in a reference number refer to the figure number in which that element is first introduced.

In the drawings:

FIG. 1 illustrates aspects of a RAID system, in accordance with example embodiments;

FIG. 2 illustrates aspects of a layout of data blocks in the RAID system of FIG. 1, in accordance with example embodiments;

FIGS. 3-4 illustrate aspects of converting a RAID system, in accordance with example embodiments;

FIGS. 5-6 illustrate aspects of methods of storing data within a RAID system, in accordance with example embodiments; and

FIG. 7 illustrates aspects of a computing device or computing system in accordance with example embodiments.

### DETAILED DESCRIPTION

Example embodiments generally relate to data storage, e.g., providing data redundancy and error correction for disk utilization. More specifically, at least some embodiments relate to systems, hardware, software, computer-readable media, and methods for providing double parity RAID (Redundant Array of Inexpensive Disks) storage in computer systems.

Disclosed herein are techniques for double parity RAID management for improving disk utilization. In example embodiments, the present RAID system is configured to support double parity. In some embodiments, the present RAID system is configured to calculate one distributed parity block, P, that is written among data blocks in rotation amongst data storage disks. The present RAID system is further configured to calculate one dedicated parity block, Q, that is stored on a parity disk. In example embodiments, the parity disk can be a dedicated disk configured to store a plurality of dedicated parity blocks.

Specific embodiments will now be described in detail with reference to the accompanying figures. In the following detailed description of example embodiments, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

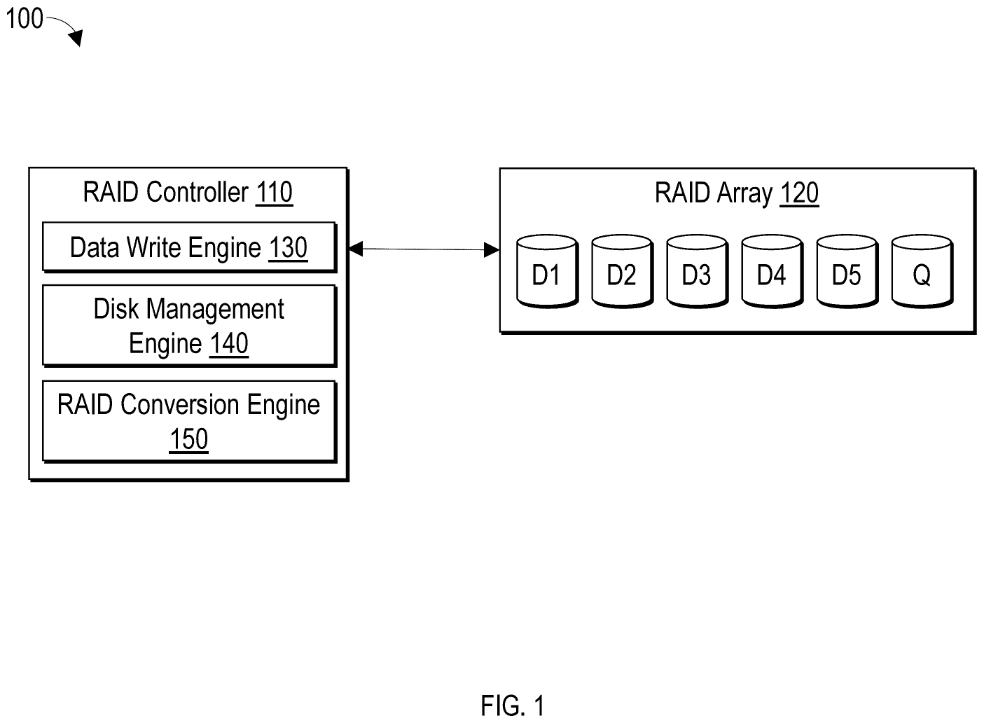

FIG. 1 shows aspects of a RAID system, in accordance with example embodiments. In particular, FIG. 1 illustrates a RAID system 100 including a RAID controller 110 and a RAID array 120 of disks. In the illustrated example, the RAID array includes five data storage disks (D1-D5) and one parity disk (Q).

The controller 110 includes a data write engine 130, a disk management engine 140, and a RAID conversion engine 150. In example embodiments, the controller 110 can be used by a redundancy engine of the RAID system 100. Operation of each of these units is discussed in greater detail herein.

The array 120 contains one or more disks. The disks can be data disks, where each disk is configured to store data blocks. The data disks can comprise data storage disks or a parity disk. In the illustrated example, the data storage disks include D1-D5 and the parity disk includes Q. In example embodiments, the parity disk can be a standalone disk. The data blocks can include data storage blocks and parity data blocks. The data storage disks are configured to store data storage blocks alongside distributed parity blocks. The parity disk is configured to store dedicated parity blocks, as described in further detail below.

Example embodiments of the array 120 may include a plurality of solid state drives (SSD) as opposed to magnetic disks. In various embodiments, SSDs may be random access, whereas magnetic disks may be mechanical devices with momentum. In certain embodiments, the magnetic disks may be most efficient where data readout may be largely serial and having uneven sizes of columns between stripes causes the magnetic disks to work inefficiently. In some embodiments, SSDs however may be solid state with no momentum issues and thus the present embodiments may be well suited to an array of SSD devices, or any other random access device.

The data write engine 130 is configured for writing initial data into the array 120. In example embodiments, the data write engine is configured to write a distributed parity block, P, corresponding to the data blocks in a given RAID stripe. The distributed parity block can be calculated consistent with parity approaches used in single parity systems such as, for example, RAID 4 and 5. In some embodiments, the data write engine is configured to rotate the data blocks and the distributed parity block amongst the data disks in the array, consistent with layouts used in single parity systems. Each of these operations is discussed in further detail herein.

The disk management engine 140 is configured for managing the addition and removal of data disks into the RAID system 100. Advantageously, the RAID system allows for dynamic addition and removal of data disks, including dedicated parity disks (shown as parity disk Q in the array 120). As data disks are added and removed, membership in a reserved space pool of the redundancy engine can be adjusted dynamically to improve disk utilization while continuing to meet and exceed service level commitments, as described in greater detail herein.

The RAID conversion engine 150 is configured for converting between RAID levels. For example, the RAID system 100 advantageously allows for substantially faster conversion times such as in the course of converting between a single parity RAID array and the array 120. In example embodiments, the conversion can be between a RAID 5 layout and the RAID system, as described in further detail herein.

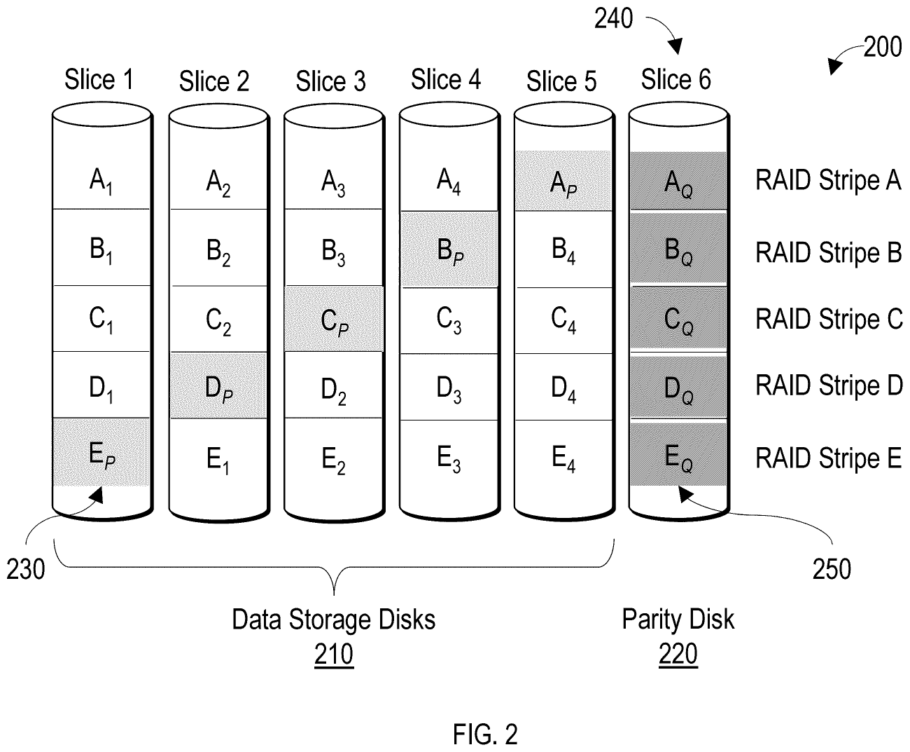

FIG. 2 shows aspects of a layout of data blocks in the present RAID system, in accordance with example embodiments. In particular, FIG. 2 illustrates an environment 200 including data storage disks 210 and a parity disk 220.

In example embodiments, the data storage disks 210 are configured to store data blocks. FIG. 2 illustrates data including RAID stripes A-E striped across RAID slices 1-5 using five rows of data. In the illustrated example, the data blocks include data storage blocks for RAID stripe A comprising data storage blocks A₁-A₄, RAID stripe B comprising data storage blocks B₁-B₄, RAID stripe C comprising data storage blocks C₁-C₄, RAID stripe D comprising data storage blocks D-D, and RAID stripe E comprising data storage blocks E₁-E₄. The data blocks can be block striped and written to the data storage disks 210. In the illustrated example, a left asymmetric layout is shown. It will be further appreciated that the data blocks can be written and rotated in accordance with a left asymmetric layout, a left symmetric layout, a right asymmetric layout, a right symmetric layout, or the like without departing from the scope of the invention.

The data blocks also include distributed parity data blocks 230. In the illustrated example, the distributed parity data blocks include A_{P}, B_{P}, C_{P}, D_{P}, and E_{P}. The distributed parity blocks can be calculated using a parity function similar to parity calculations for RAID 4 or RAID 5 systems. In example embodiments, the parity function can be a horizontal parity calculated based on the data storage blocks. For example, the parity function can be a bitwise exclusive or (XOR) function.

In example embodiments, the data storage disks 210 are configured to store the distributed parity data blocks 230. In the illustrated example, a left asymmetric layout is shown for the data storage disks. It will be further appreciated that the distributed parity blocks can be written and rotated in accordance with a left asymmetric layout, a left symmetric layout, a right asymmetric layout, a right symmetric layout, or the like without departing from the scope of the invention.

The parity disk 220 can be a dedicated disk. For example, the parity disk can be a standalone disk configured to store dedicated parity blocks 250. In the illustrated example, the dedicated disk is RAID slice 6 240 that supplements the data storage disks 210 (e.g., RAID slices 1-5). The dedicated parity blocks can be calculated using a parity function similar to parity calculations for the Q parity function in RAID 6 systems. In example embodiments, the parity function can be a horizontal parity calculated based on the data storage blocks. For example, the parity function can be a Reed-Solomon function, or more generally Galois field arithmetic (also referred to as finite field), matrix operations, and the like.

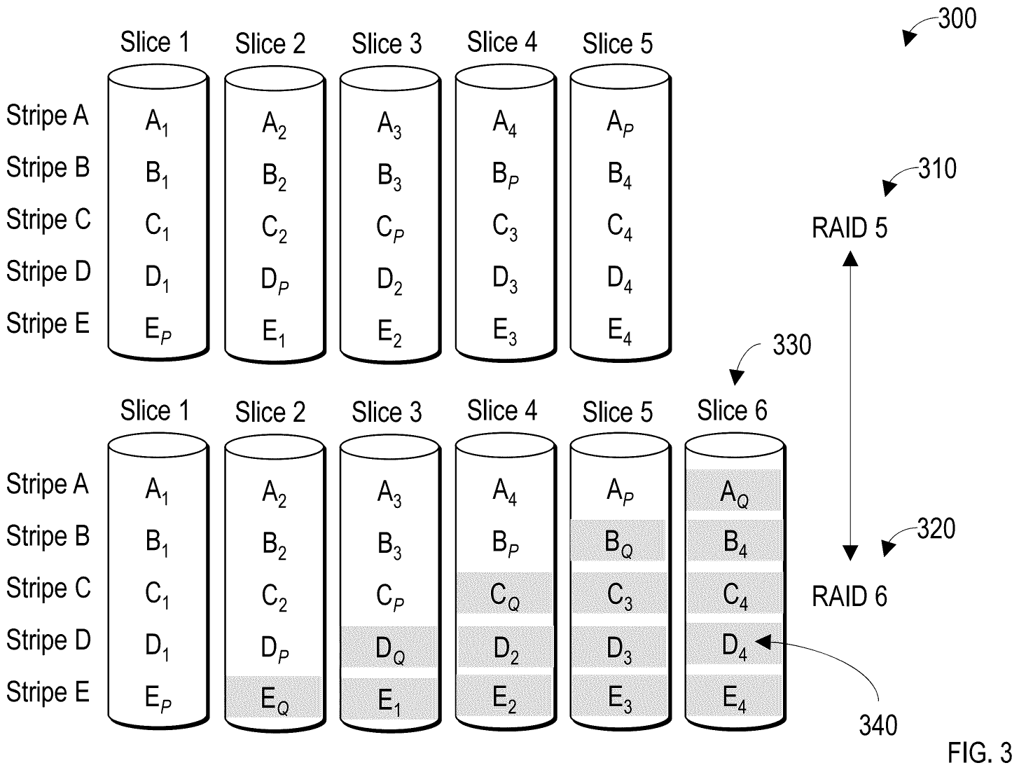

FIG. 3 shows aspects of converting a RAID system, in accordance with example embodiments. In particular, FIG. 3 illustrates an example conversion 300 between a RAID 5 array 310 and a RAID 6 array 320.

In the RAID 5 array 310, the array includes RAID slices 1-5. In the illustrated example RAID slices 1-5, the data blocks are rotated throughout the slices according to a conventional RAID 5 arrangement, e.g., that rotates a distributed parity block amongst the RAID slices. For example, the arrangement can be a left asymmetric layout. Other layouts (such as right asymmetric, left symmetric, right symmetric, and the like) can be converted without departing from the scope of the invention.

A RAID 6 array 320 is the desired result of the conversion 300. For example, if a conventional RAID 6 array of six slices is desired, then a new data drive 330 will be required to be added (e.g., RAID slice 6 as illustrated in FIG. 3). Further, in a conventional RAID 6 array, a second distributed parity block, commonly referred to as Q, is added in support of double parity. For the illustrated example RAID stripes A-E, the second distributed parity block includes A_{Q}, B_{Q}, C_{Q}, D_{Q}, and E_{Q}. The Q distributed parity block can be rotated amongst the data storage disks (e.g., RAID slices 1-6), and typically follows the P distributed parity block A_{P}, B_{P}, C_{P}, D_{P}, and E_{P}, for example in conventional left P-top asymmetric or left P-top symmetric layouts.

It is noted that, when the conversion 300 entails upconverting from a RAID 5 array 310 to a RAID 6 array 320, a significant portion 340 of the data blocks (shown in gray in FIG. 3) are required to be moved from one RAID slice to another. For example, the illustrated data blocks B₄, C₄, D₄, and E₄ all require transfer operations to move the data blocks from RAID slice 5 in the RAID 5 array to RAID slide 6 in the RAID 6 array. These transfer operations can result in an undesirably long duration for converting between a single parity and a conventional double parity system, such as conventional RAID 6.

Similarly, when the conversion 300 entails converting from a RAID 6 array 320 to a RAID 5 array 310, the portion 340 of the data blocks require transfer operations to move the data blocks to new RAID slices. In some embodiments, RAID slice 6 330 can be reclaimed upon completion of the downconversion. For example, the RAID slice can be included as spare space or parity space and made available in a redundancy engine, as discussed in further detail herein.

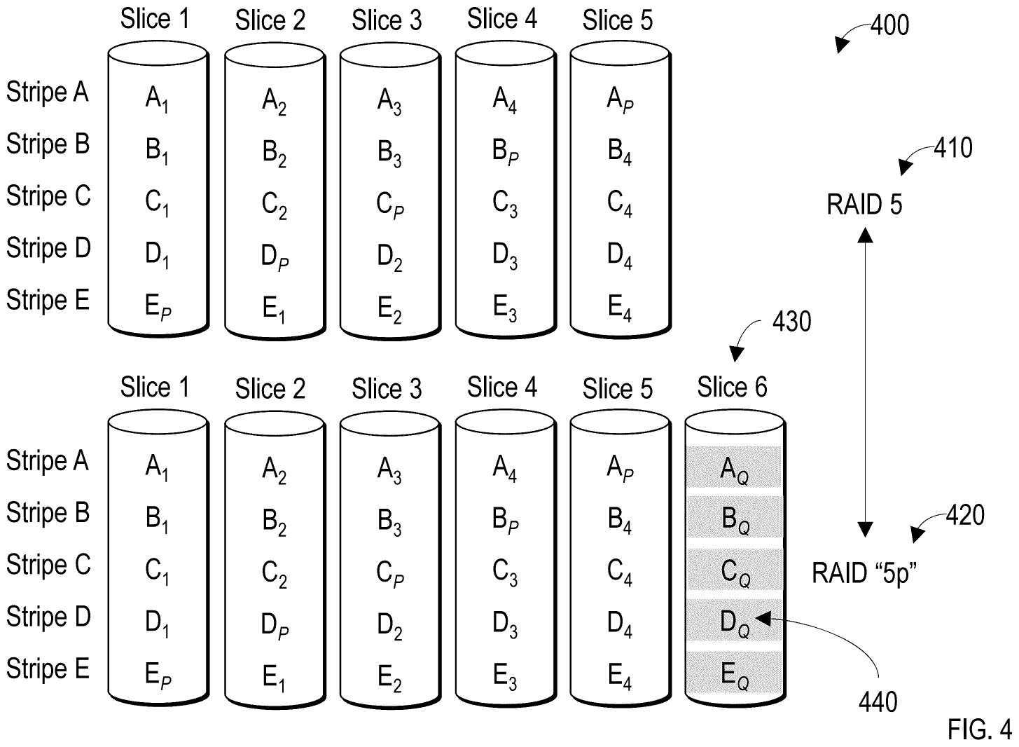

FIG. 4 shows aspects of converting a RAID system, in accordance with example embodiments. In particular, FIG. 4 illustrates an example conversion 400 between a RAID 5 array 410 and a RAID array 420 configured on the present RAID system.

The RAID 5 array 410 can be similar to the RAID 5 array 310 that includes RAID slices 1-5. The data blocks are rotated throughout the slices according to a conventional RAID 5 arrangement, e.g., which rotates a distributed parity block amongst the RAID slices, as described in connection with FIG. 3. In the illustrated example, the arrangement is a left asymmetric layout. Other layouts such as right asymmetric, left symmetric, right symmetric, and the like can be converted without departing from the scope of the invention.

A RAID array 420 is the desired result of the conversion 400. For example, if a RAID array of six slices in the present RAID system is desired, then a new data drive 430 will be added in a manner similar to FIG. 3 (e.g., RAID slice 6 430 as illustrated in FIG. 4). Also similar to the RAID 6 array 320, a second parity block 440, referred to as Q, is added in support of double parity. For the illustrated example RAID stripes A-E, the second parity block includes A_{Q}, B_{Q}, C_{Q}, D_{Q}, and E_{Q}.

In contrast to the distributed parity blocks shown in FIG. 3, in example embodiments the dedicated parity blocks 440 used in the present RAID array 400 are stored in the dedicated drive 430.

Advantageously, when the conversion 400 involves converting from a RAID 5 array 410 to the present RAID array 420, the conversion can include allocating a new dedicated disk 430 and storing the dedicated parity blocks 440 in the new dedicated disk. In example embodiments, the dedicated disk can be a parity disk and allocated from spare space by a redundancy engine. In contrast, the conversion 300 to a conventional RAID 6 system 320 requires transfer operations that involve moving a significant portion 340 of the data blocks from one RAID slice to another, resulting in an undesirably long duration. Accordingly it will be appreciated that the present RAID system allows the conversion 400 to provide the advantages of double parity while being substantially faster than conventional double parity RAID systems such as RAID 6.

Similarly, when the conversion 400 involves converting from the present RAID array 420 to the RAID 5 array 410, the dedicated disk 430 can simply be removed from the present RAID array. This removal transforms the array into a single parity array such as the RAID 5 array. In some embodiments, RAID slice 6 430 can be reclaimed upon completion of the downconversion. For example, the RAID slice can be included as spare space or parity space and made available in a redundancy engine.

The present RAID system provides numerous technical advantages. For example, the present RAID system supports double parity. In some embodiments, the system supports failures in potentially two data disks, such as two failed data storage disks or a failure of one data storage disk along with the parity disk. In other embodiments, such as environments combining single parity RAID configurations with the present RAID configuration, the double parity provided by the present techniques offers enhanced reliability compared with conventional purely single parity systems. Such hybrid combined environments can sometimes be referred herein to as RAID “5p” (as shown in the array 420), representing an improvement between pure RAID 5 and pure RAID 6 configurations. Accordingly, double parity support provides substantially improved reliability relative to single parity, mirror-based redundancy, or no redundancy.

Further, the present RAID system improves disk utilization. The present RAID system be configured to support RAID resiliency sets (RRS), which can refer to a group of drives acting as a single failure domain. RRSes can improve reliability in, for example, products such as the PowerStore storage product family provided by Dell Technologies. In conventional architectures that use an RRS size of 25, typically 1 disk is reserved so as to satisfy service level reliability requirements for a conventional single parity RAID system, e.g., RAID 5. Accordingly, presuming a hypothetical array of 100 total data disks, 4 disks would be reserved as spare space in a redundancy engine, resulting in about 85.3 disks of usable space (=(25−1)×4×8/9).

In contrast, the present RAID system provides an improvement of about 2.7 disks worth of additional capacity in a hypothetical 100 disk array, as follows. First, the present RAID system allows an associated redundancy engine to avoid legacy limitations restricting RRS size to 25 disks. Removing this limitation advantageously allows products incorporating the present RAID techniques to support 16+1 configurations, e.g., 16 data storage disks along with 1 parity disk. Accordingly, supporting a 100 disk array using a 16+1+Q configuration (e.g., adding Q disks for storing dedicated parity blocks) results in about 88 disks of usable space (=(100−1)×16/18). Compared with about 85.3 disks in a conventional RAID 5 layout, the present system improves available capacity, such as by adding about 2.7 disks of usable space.

Additionally, as mentioned the present RAID system can include a redundancy engine. Example embodiments of a redundancy engine can include the Dynamic Resiliency Engine (DRE) provided in the PowerStore storage product family. In a deployment scenario in which merely single parity support is guaranteed to an end user, for example in connection with commitments such as service level agreements (SLA), then the present RAID system can be configured to leverage double parity support and provide enhanced reliability internally, thereby exceeding published service level commitments. The redundancy engine can generally include a representation of aggregate space provided by the underlying drives, including usable space and reserved space. Example embodiments of reserved space can include spare space and parity space. Advantageously, adopting the present RAID system in a configuration in which only single parity redundancy is expected allows the redundancy engine to leverage the parity drive as spare space. In some embodiments, the parity drive can be included in a shared space pool of the redundancy engine, as discussed in further detail herein.

As mentioned, including the parity drive in a shared space pool generally allows the redundancy engine to allocate at least some RAID slices for the parity disk from spare space, such as during normal operation of the redundancy engine. Advantageously, if the redundancy engine enters a degraded mode, such as when one or more disk failures are detected, in some embodiments the redundancy engine is configured to convert at least some arrays from the present RAID configuration supporting double parity down to a single parity RAID configuration, such as a RAID 5 configuration. As mentioned, advantageously such conversion can be completed quickly, since only the parity disk is reclaimed in connection with the conversion without needing to perform any transfer operations in connection with moving data blocks on the data storage disks. In some embodiments, the parity drive can be allocated to spare space. For example, the allocation to spare space can include merely an update to associated metadata or properties of the parity disk (such as marking the parity disk as belonging to a spare space pool instead of a parity space pool). The redundancy engine can continue to operate in degraded mode, for example in a single parity configuration, until replacement of the failed disk.

As discussed, one technical advantage includes an ability for the allocation and corresponding size of the reserved capacity to vary dynamically as RAID slices from the parity disk are allocated amongst parity space and spare space. In some embodiments, available capacity from the parity disk can also be allocated dynamically amongst reserved space and usable space. This dynamic allocation is achieved partly by leveraging the speed of conversion between the present RAID system and single parity RAID, such as RAID 5. For example, with a conventional RAID 5 configuration and RRS of 100 total disks, the rebuild time associated with a service level commitment of “five nines” (e.g., 99.999% uptime) is about 97 hours based on presently available configurations. Advantageously, the conversion between the present RAID system and RAID 5 as described above can be completed in about 4.5 hours to rebuild a degraded disk, far exceeding a “five nines” commitment. Accordingly, it is appreciated that the present RAID system can easily convert to a conventional RAID 5 system by reclaiming the parity disk, thereby allowing excess parity disk capacity to be allocated to a usable space pool of the redundancy engine and accordingly released to end users. Advantageously, the present RAID system thus allows usable capacity to vary dynamically as RRS size varies, reflecting an ability to reclaim parity disk capacity quickly and efficiently without undesired effects to existing service commitments.

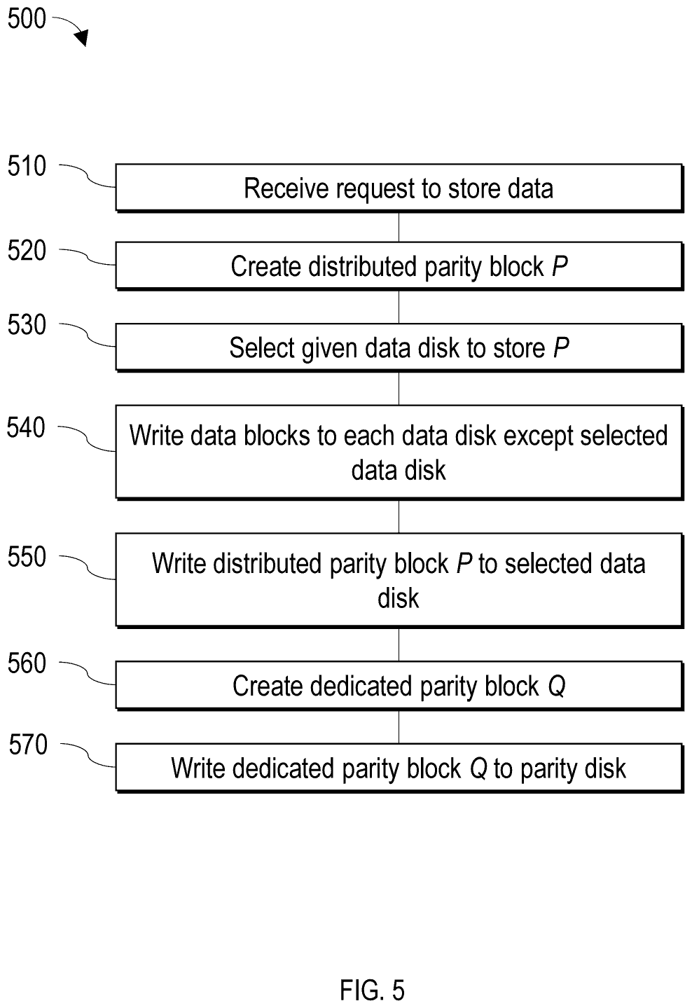

FIG. 5 illustrates aspects of a method 500, in accordance with example embodiments. In example embodiments, the method 500 allows for storing data within the RAID system 100.

In some embodiments, the method 500 can be performed by the RAID system 100, such as using a RAID controller 110 via a redundancy engine.

In example embodiments, the method 500 includes receiving a request to store data in data storage disks (step 510). The received data can be segmented into data blocks. In some embodiments, the request can be received by a RAID controller 110 and the data storage disks can form part of a RAID array.

In example embodiments, the method 500 includes creating a distributed parity block, P (step 520). The distributed parity block can be created based on the received data. For example, the distributed parity block can include a horizontal parity that is calculated based on the data blocks. The horizontal parity can be calculated using bitwise exclusive or (XOR) operations on the data blocks.

In example embodiments, the method 500 includes selecting a given data storage disk among the data storage disks to store the distributed parity block (step 530). The given data storage disk can be rotated among the data storage disks.

In example embodiments, the method 500 includes writing the data blocks to each data storage disk among the data storage disks except the selected data storage disk (step 540). For example, the data blocks can be written according to a left asymmetric layout, left symmetric layout, right asymmetric layout, right symmetric layout, or the like.

In example embodiments, the method 500 includes writing the distributed parity block to the selected data storage disk (step 550). For example, the distributed parity block can be written according to a left asymmetric layout, left symmetric layout, right asymmetric layout, or right symmetric layout, or the like.

In example embodiments, the method 500 includes creating a dedicated parity block, Q (step 560). The dedicated parity block can be calculated based on the received data. For example, the dedicated parity block can include a horizontal parity calculated based on the data blocks. In some embodiments, the horizontal parity can be calculated using Reed-Solomon coding, Galois field arithmetic, or matrix operations based on the data blocks.

In example embodiments, the method 500 includes writing the dedicated parity block to a parity disk (step 570). For example, the parity disk can be a standalone dedicated disk. A capacity of the parity disk can be included in a reserved capacity of a redundancy engine. In some embodiments, the reserved capacity can include parity space and spare space.

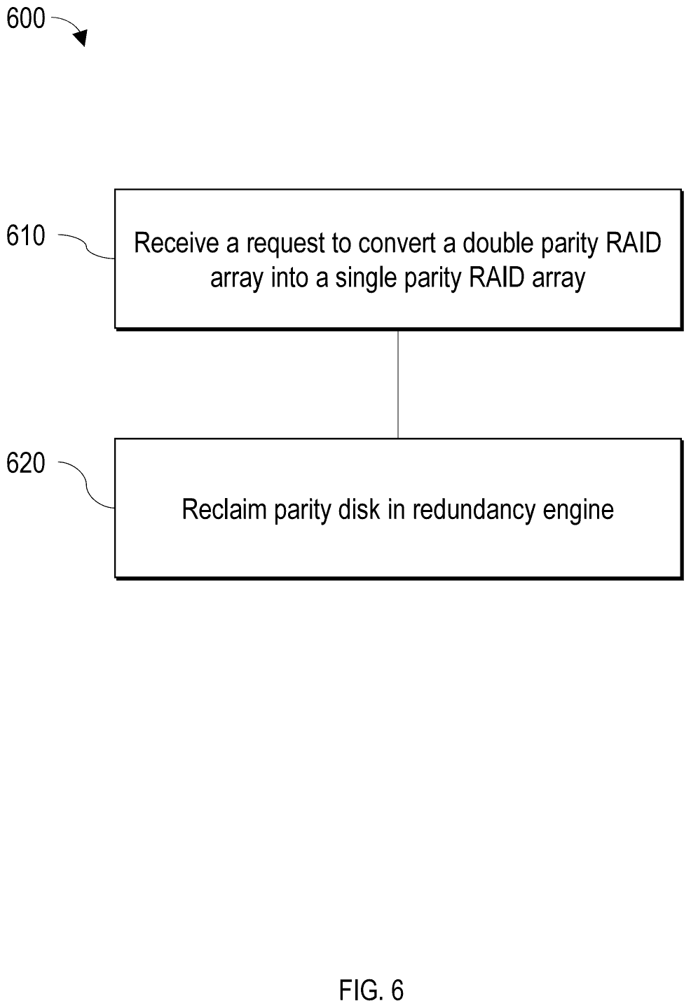

FIG. 6 illustrates aspects of a method 600, in accordance with example embodiments. In example embodiments, the method 600 allows for storing data within the RAID system 100.

In some embodiments, the method 600 can be performed by the RAID system 100, such as by a redundancy engine configured to use a RAID controller 110.

In example embodiments, the method 600 includes receiving a request to convert a double parity RAID array into a single parity RAID array (step 610). The double parity RAID array can include data storage disks and a parity disk, such as used in the present RAID system. The data storage disks can be configured to store data blocks and distributed parity blocks. The parity disk can be configured to store dedicated plurality blocks. In some embodiments, the parity disk can be a standalone dedicated disk. For example, the single parity array can be a RAID 5 array.

In example embodiments, the method 600 includes reclaiming the parity disk in a redundancy engine by removing the parity disk as parity capacity in the redundancy engine (step 620). Advantageously, reclaiming the parity disk avoids a need to perform transfer operations on the data blocks or the distributed parity blocks stored on the data storage disks. In some embodiments, the parity disk can be reclaimed as spare capacity in the redundancy engine. For example, a capacity of the parity disk can be included in a spare capacity of the redundancy engine. In alternate embodiments, the parity disk can be reclaimed as usable capacity in the redundancy engine.

While the various steps in the example methods 500, 600 have been presented and described sequentially, one of ordinary skill in the art, having the benefit of this disclosure, will appreciate that some or all of the steps may be executed in different orders, that some or all of the steps may be combined or omitted, and/or that some or all of the steps may be executed in parallel.

It is noted with respect to the example methods 500, 600 that any of the disclosed processes, operations, methods, and/or any portion of any of these, may be performed in response to, as a result of, and/or, based upon, the performance of any preceding process(es), methods, and/or, operations. Correspondingly, performance of one or more processes, for example, may be a predicate or trigger to subsequent performance of one or more additional processes, operations, and/or methods. Thus, for example, the various processes that may make up a method may be linked together or otherwise associated with each other by way of relations such as the examples just noted. Finally, and while it is not required, the individual processes that make up the various example methods disclosed herein are, in some embodiments, performed in the specific sequence recited in those examples. In other embodiments, the individual processes that make up a disclosed method may be performed in a sequence other than the specific sequence recited.

As mentioned, at least portions of the RAID system 100 can be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

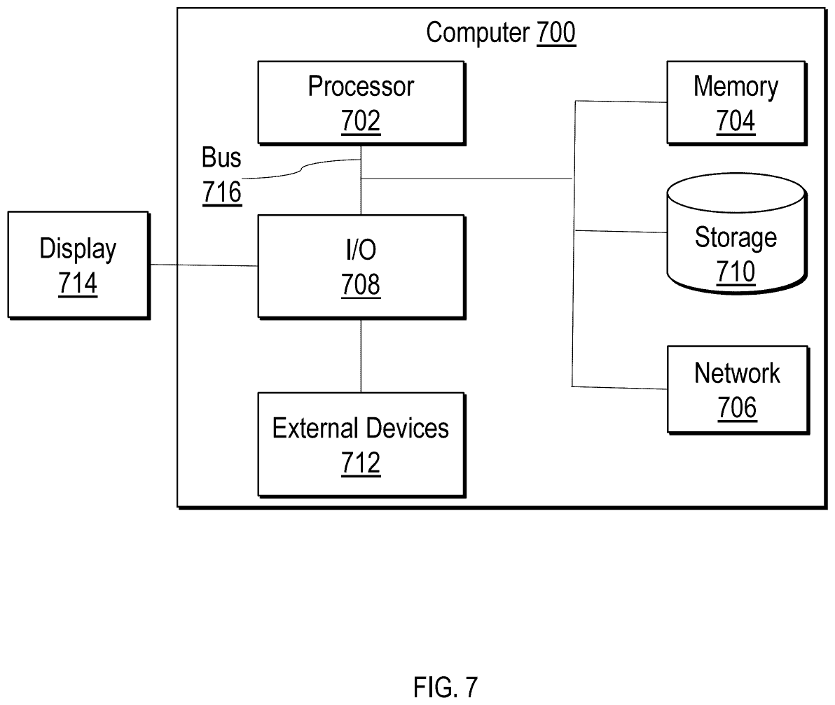

Illustrative embodiments of processing platforms will now be described in greater detail with reference to FIG. 7. Although described in the context of the system 100, these platforms may also be used to implement at least portions of other information processing systems in other embodiments.

FIG. 7 illustrates aspects of a computing device or a computing system in accordance with example embodiments. The computer 700 is shown in the form of a general-purpose computing device. Components of the computer may include, but are not limited to, one or more processors or processing units 702, a memory 704, a network interface 706, and a bus 716 that communicatively couples various system components including the system memory and the network interface to the processor.

The bus 716 represents one or more of any of several types of bus structures, including a memory bus or memory controller, a peripheral bus, an accelerated graphics port, and a processor or local bus using any of a variety of bus architectures. By way of non-limiting example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The computer 700 typically includes a variety of computer-readable media. Such media may be any available media that is accessible by the computer system, and such media includes both volatile and non-volatile media, removable and non-removable media.

The memory 704 may include computer system readable media in the form of volatile memory, such as random-access memory (RAM) and/or cache memory. The computer system may further include other removable/non-removable, volatile/non-volatile computer system storage media. By way of example only, the storage system 710 may be provided for reading from and writing to a non-removable, non-volatile magnetic media (not shown and typically called a “hard drive”) in accordance with the present RAID techniques. Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media may be provided. In such instances, each may be connected to the bus 516 by one or more data media interfaces. As has been depicted and described above in connection with FIGS. 1-6, the memory may include at least one computer program product having a set (e.g., at least one) of program modules that are configured to carry out the functions of the embodiments as described herein.

The computer 700 may also include a program/utility, having a set (at least one) of program modules, which may be stored in the memory 704 by way of non-limiting example, as well as an operating system, one or more application programs, other program modules, and program data. Each of the operating system, one or more application programs, other program modules, and program data or some combination thereof, may include an implementation of a networking environment. The program modules generally carry out the functions and/or methodologies of the embodiments as described herein.

The computer 700 may also communicate with one or more external devices 712 such as a keyboard, a pointing device, a display 714, etc.; one or more devices that enable a user to interact with the computer system; and/or any devices (e.g., network card, modem, etc.) that enable the computer system to communicate with one or more other computing devices. Such communication may occur via the Input/Output (I/O) interfaces 708. Still yet, the computer system may communicate with one or more networks such as a local area network (LAN), a general wide area network (WAN), and/or a public network (e.g., the Internet) via the network adapter 706. As depicted, the network adapter communicates with the other components of the computer system via the bus 716. It should be understood that although not shown, other hardware and/or software components could be used in conjunction with the computer system. Non-limiting examples include microcode, device drivers, redundant processing units, external disk drive arrays, RAID systems, tape drives, data archival storage systems, and the like.

It is noted that embodiments of the invention, whether claimed or not, cannot be performed, practically or otherwise, in the mind of a human. Accordingly, nothing herein should be construed as teaching or suggesting that any aspect of any embodiment could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

In the foregoing description of FIGS. 1-7, any component described with regard to a figure, in various embodiments of the invention, may be equivalent to one or more like-named components described with regard to any other figure. For brevity, descriptions of these components has not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment which may be implemented in addition to, in conjunction with, or in place of the embodiments described with regard to a corresponding like-named component in any other figure.

Throughout the disclosure, ordinal numbers (e.g., first, second, third, etc.) may have been used as an adjective for an element (i.e., any noun in the application). The use of ordinal numbers is not to necessarily imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and a first element may encompass more than one element and succeed (or precede) the second element in an ordering of elements.

Throughout this disclosure, elements of figures may be labeled as “a” to “n”. As used herein, the aforementioned labeling means that the element may include any number of items and does not require that the element include the same number of elements as any other item labeled as “a” to “n.” For example, a data structure may include a first element labeled as “a” and a second element labeled as “n.”. This labeling convention means that the data structure may include any number of the elements. A second data structure, also labeled as “a” to “n,” may also include any number of elements. The number of elements of the first data structure and the number of elements of the second data structure may be the same or different.

While the invention has been described with respect to a limited number of embodiments, those of ordinary skill in the art, having the benefit of this disclosure, will appreciate that other embodiments can be devised that do not depart from the scope of the invention as disclosed herein. Accordingly, the scope of the invention should be limited only by the appended claims.

What is claimed is:

1. A system comprising:
at least one processing device including a processor coupled to a memory;
the at least one processing device being configured to implement the following steps:
receiving a request to store data in a plurality of data storage disks, wherein the received data is segmented into a plurality of data blocks;
creating a distributed parity block P, wherein the distributed parity block is calculated based on the received data;
selecting a given data storage disk among the plurality of data storage disks to store the distributed plurality block, wherein the given data storage disk is rotated among the plurality of data storage disks;
writing the data blocks to each data storage disk among the plurality of data storage disks except the selected data storage disk;
writing the distributed parity block to the selected data storage disk;
creating a dedicated parity block Q, wherein the dedicated parity block is calculated based on the received data; and
writing the dedicated parity block to a parity disk.

2. The system of claim 1, wherein the distributed parity block P comprises a horizontal parity calculated based on the data blocks.

3. The system of claim 2, wherein the horizontal parity is calculated using bitwise exclusive or (XOR) operations based on the data blocks.

4. The system of claim 1, wherein the dedicated parity block Q comprises a horizontal parity calculated based on the data blocks.

5. The system of claim 4, wherein the horizontal parity is calculated using Reed-Solomon coding, Galois field arithmetic, or matrix operations based on the data blocks.

6. The system of claim 1, wherein the parity disk comprises a standalone dedicated disk.

7. The system of claim 1, wherein the data blocks and/or the distributed parity block can be written according to one of a left asymmetric layout, a left symmetric layout, a right asymmetric layout, and a right symmetric layout.

8. The system of claim 1, wherein a capacity of the parity disk is included in a reserved capacity of a redundancy engine.

9. The system of claim 8, wherein the reserved capacity comprises a spare capacity of the redundancy engine.

10. A non-transitory processor-readable storage medium having stored thereon program code of one or more software programs, wherein the program code when executed by at least one processing device causes the at least one processing device to perform the following steps:
receiving a request to store data in a plurality of data storage disks, wherein the received data is segmented into a plurality of data blocks;
creating a distributed parity block P, wherein the distributed parity block is calculated based on the received data;
selecting a given data storage disk among the plurality of data storage disks to store the distributed plurality block, wherein the given data storage disk is rotated among the plurality of data storage disks;
writing the data blocks to each data storage disk among the plurality of data storage disks except the selected data storage disk;
writing the distributed parity block to the selected data storage disk;
creating a dedicated parity block Q, wherein the dedicated parity block is calculated based on the received data; and
writing the dedicated parity block to a parity disk.

11. The processor-readable storage medium of claim 10, wherein the distributed parity block P comprises a horizontal parity calculated based on the data blocks, and the horizontal parity is calculated using bitwise exclusive or (XOR) operations based on the data blocks.

12. The processor-readable storage medium of claim 10, wherein the dedicated parity block Q comprises a horizontal parity calculated based on the data blocks, and the horizontal parity is calculated using Reed-Solomon coding, Galois field arithmetic, or matrix operations based on the data blocks.

13. The processor-readable storage medium of claim 10, wherein the parity disk comprises a standalone dedicated disk.

14. The processor-readable storage medium of claim 10, wherein a capacity of the parity disk is included in a reserved capacity of a redundancy engine, and the reserved capacity comprises a spare capacity of the redundancy engine.

15. A method comprising:
receiving a request to convert a double parity RAID array into a single parity RAID array, the double parity RAID array including a plurality of data storage disks and a parity disk, wherein the data storage disks are configured to store a plurality of data blocks and a plurality of distributed parity blocks, and the parity disk is configured to store a plurality of dedicated plurality blocks; and
reclaiming the parity disk in a redundancy engine by removing the parity disk as parity capacity in the redundancy engine, without a need to perform transfer operations on the data blocks or the distributed parity blocks stored on the data storage disks.

16. The method of claim 15, wherein the parity disk is reclaimed as spare capacity in the redundancy engine.

17. The method of claim 15, wherein the parity disk is reclaimed as usable capacity in the redundancy engine.

18. The method of claim 15, wherein the parity disk comprises a standalone dedicated disk.

19. The method of claim 15, wherein a capacity of the parity disk is included in a spare capacity of a redundancy engine.

20. The method of claim 15, wherein the single parity RAID array comprises a RAID 5 array.
